(19) United States
(12) Patent Application Publication
(10) Pub. No.: US 2023/0159681 A1
(43) Pub. Date: May 25, 2023

(54) COMPOSITION COMPRISING A COPOLYMER COMPRISING MONOMERS OF METHYL METHACRYLATE AND METHACRYLIC ACID, ITS USE AND MOULDED OBJECT

(71) Applicant: Trinseo Europe GmbH, Horgen (CH)

(72) Inventors: Sylvain Queruel, Serquigny (FR); Estelle Pierrat, Serquigny (FR)

(73) Assignee: Trinseo Europe GmbH, Horgen (CH)

(21) Appl. No.: 17/917,823

(22) PCT Filed: Apr. 28, 2021
(86) PCT No.: PCT/EP2021/061162

§ 371 Date: Oct. 7, 2022

(30) Foreign Application Priority Data
Apr. 30, 2020 (FR) FR2004328

(51) Int. Cl. C08F 220/14

(52) U.S. Cl. CPC C08F 220/14

(57) ABSTRACT

The present invention relates to a polymeric composition suitable for making moulded objects that resists to chemicals, said composition is comprising a polymer comprising monomers of methyl methacrylate and methacrylic acid, its use, moulded object comprising and use of molded object. In particular the present invention relates to the use of a polymeric composition suitable for making moulded objects that resists to chemicals, said polymeric composition is comprising monomers of methyl methacrylate and methacrylic acid, for making moulded objects and more particular solvent resistant moulded object. The present invention concerns also process for making a solvent resistant moulded object comprising a polymer comprising monomers of methyl methacrylate and methacrylic acid. The present invention concerns especially use of a polymer comprising monomers of methyl methacrylate and methacrylic acid for point of sales and a moulded object used for point of sales comprising a polymer comprising monomers of methyl methacrylate and methacrylic acid.

### FIELD OF THE INVENTION

The present invention relates to a polymeric composition suitable for making moulded objects that resists to chemicals, said composition is comprising a polymer comprising monomers of methyl methacrylate and methacrylic acid, its use, moulded object comprising and use of molded object.

In particular the present invention relates to the use of a polymeric composition suitable for making moulded objects that resists to chemicals, said polymeric composition is comprising monomers of methyl methacrylate and methacrylic acid, for making moulded objects and more particular solvent resistant moulded object.

The present invention concerns also process for making a solvent resistant moulded object comprising a polymer comprising monomers of methyl methacrylate and methacrylic acid.

The present invention concerns especially use of a polymer comprising monomers of methyl methacrylate and methacrylic acid for point of sales and a moulded object used for point of sales comprising a polymer comprising monomers of methyl methacrylate and methacrylic acid.

### Technical Problem

Thermoplastic polymers and copolymers, especially (meth)acrylic ones, have excellent characteristics such as transparency, mechanical properties and processability and are widely used in various fields such as automobile parts, electrical parts, industrial parts, optical materials, various parts of household electrical appliances, aesthetical parts, miscellaneous goods and the like.

It is of great interest to have polymeric compositions based on (meth)acrylic polymers that have good properties in various fields or in other words an increased light transmittance, good scratch resistance.

Additionally it is of also of great interest to have a polymeric composition with better chemical resistance, especially solvent resistance. This can be achieved by adding certain compounds or make polymer blends. However adding polymer additives or blend several compounds has the drawback that other characteristics of the polymer are lost, as for example transparency, scratch resistance or clarity.

The objective of the present invention is to provide a (meth)acrylic polymer composition with satisfying solvent or chemical resistance.

A further objective of the present invention is to provide a (meth)acrylic polymer composition that can be used in solvent resistant applications.

A still further objective of the present invention is to provide a process for producing a molded object comprising a (meth)acrylic polymer composition with a satisfying solvent resistance.

Another objective of the present invention is to provide a (meth)acrylic polymer composition with satisfying solvent resistance, that comprises essentially no other compound as polymer additives of other polymers.

Another objective of the present invention is to provide a (meth)acrylic polymer composition that can be used in solvent resistant objects.

Another objective of the present invention is to provide process for making solvent resistant moulded or extruded objects that comprises a (meth)acrylic polymer.

Another objective of the present invention is to provide an object with satisfying solvent resistance comprising a (meth)acrylic polymer composition.

### BACKGROUND OF THE INVENTION

### Prior Art

The document WO2018/054999 discloses a polymeric (meth)acrylic composition comprising a (meth)acrylic polymer and a copolymer comprising at least 41% wt of a vinyl aromatic monomer, (meth)acrylic acid ester monomer and dicarboxylic acid anhydride monomer for increasing the chemical resistance.

The prior art discloses a polymeric composition comprising a (meth)acrylic copolymer that is blended with another polymer. There is no polymer composition comprising in a copolymer monomers of methyl methacrylate and methacrylic acid in the prior art that does disclose anything about the chemical resistance or the use in chemical resistant applications or objects.

### BRIEF DESCRIPTION OF THE INVENTION

Surprisingly it has been discovered that a polymeric composition (PC1) comprising a (meth)acrylic copolymer (MP1) comprising monomers of methyl methacrylate and methacrylic acid characterized in that the (meth)acrylic copolymer (MP1) has a weight average molecular weight Mw between 50 000 g/mol and 300 000 g/mol and that the ratio of the monomeric units coming from methacrylic acid in said (meth)acrylic copolymer (MP1) is between 4 wt % and 20 wt %, increases the chemical resistance.

Surprisingly it has also been discovered that a polymeric composition (PC1) comprising a (meth)acrylic copolymer (MP1) comprising monomers of methyl methacrylate and methacrylic acid characterized in that the (meth)acrylic copolymer (MP1) has a weight average molecular weight Mw between 50 000 g/mol and 300 000 g/mol and that the ratio of the monomeric units coming from methacrylic acid in said (meth)acrylic copolymer (MP1) is between 4 wt % and 20 wt %, can be used to increase the chemical resistance It has also been found that a polymeric composition (PC1) comprising a (meth)acrylic copolymer (MP1) comprising monomers of methyl methacrylate and methacrylic acid characterized in that the (meth)acrylic copolymer (MP1) has a weight average molecular weight Mw between 50 000 g/mol and 300 000 g/mol and that the ratio of the monomeric units coming from methacrylic acid in said (meth)acrylic copolymer (MP1) is between 4 wt % and 20 wt %, can be used for making a moulded object having increased chemical resistance.

It has also been found that moulded object comprising a polymeric composition (PC1) comprising a (meth)acrylic copolymer (MP1) comprising monomers of methyl methacrylate and methacrylic acid characterized in that the (meth)acrylic copolymer (MP1) has a weight average molecular weight Mw between 50 000 g/mol and 300 000 g/mol and that the ratio of the monomeric units coming from methacrylic acid in said (meth)acrylic copolymer (MP1) is between 4 wt % and 20 wt %; possesses increased chemical resistance.

### DETAILED DESCRIPTION OF THE INVENTION

According to a first aspect, the present invention relates to a polymeric composition (PC1) suitable for making moulded objects that resist to chemicals, said composition comprises a (meth)acrylic copolymer (MP1) comprising monomers of methyl methacrylate and methacrylic acid characterized in that the (meth)acrylic copolymer (MP1) has a weight average molecular weight Mw between 50 000 g/mol and 300 000 g/mol and that the ratio of the monomeric units coming from methacrylic acid in said (meth)acrylic copolymer (MP1) is between 4 wt % and 20 wt %.

According to a second aspect the present invention relates to the use of a polymeric composition (PC1) suitable for making moulded objects, said composition comprises a (meth)acrylic copolymer (MP1) comprising monomers of methyl methacrylate and methacrylic acid characterized in that the (meth)acrylic copolymer (MP1) has a weight average molecular weight Mw between 50 000 g/mol and 300 000 g/mol and that the ratio of the monomeric units coming from methacrylic acid in said (meth)acrylic copolymer (MP1) is between 4 wt % and 20 wt % to increase the chemical resistance.

According to a third aspect the present invention relates to a moulded object comprising a polymeric composition (PC1), said composition comprises a (meth)acrylic copolymer (MP1) comprising monomers of methyl methacrylate and methacrylic acid characterized in that the (meth)acrylic copolymer (MP1) has a weight average molecular weight Mw between 50 000 g/mol and 300 000 g/mol and that the ratio of the monomeric units coming from methacrylic acid in said (meth)acrylic copolymer (MP1) is between 4 wt % and 20 wt %.

According to a fourth aspect the present invention relates to to the use of a polymeric composition (PC1) comprising a (meth)acrylic copolymer (MP1) comprising monomers of methyl methacrylate and methacrylic acid characterized in that the (meth)acrylic copolymer (MP1) has a weight average molecular weight Mw between 50 000 g/mol and 300 000 g/mol and that the ratio of the monomeric units coming from methacrylic acid in said (meth)acrylic copolymer (MP1) is between 4 wt % and 20 wt %, for making a moulded objects with increased chemical resistance.

Still another aspect of the present invention is a moulded object in form of an assembled display stand made of a polymeric composition (PC1) comprising a (meth)acrylic copolymer (MP1) comprising monomers of methyl methacrylate and methacrylic acid characterized in that the (meth)acrylic copolymer (MP1) has a weight average molecular weight Mw between 50 000 g/mol and 300 000 g/mol and that the ratio of the monomeric units coming from methacrylic acid in said (meth)acrylic copolymer (MP1) is between 4 wt % and 20 wt %.

An additional aspect of the present invention is the process for making a moulded object with increased chemical resistance by transforming a polymeric composition comprising a (meth)acrylic copolymer comprising monomers of methyl methacrylate and methacrylic acid, said process comprises the steps of
a) providing a polymeric composition (PC1) comprising a (meth)acrylic copolymer (MP1) comprising monomers of methyl methacrylate and methacrylic acid characterized in that the (meth)acrylic copolymer (MP1) has a weight average molecular weight Mw between 50 000 g/mol and 300 000 g/mol and that the ratio of the monomeric units coming from methacrylic acid in said (meth)acrylic copolymer (MP1) is between 4 wt % and 20 wt %
b) transforming the polymeric composition (PC1)
c) assembling.

By the term “alkyl(meth)acrylate” as used is denoted to both alkyl acrylate and alkyl methacrylate.

By the term “copolymer” as used is denoted that the polymers consists of at least two different monomers.

By the term “parts” as used herein is denoted “parts by weight”.

By the term “thermoplastic polymer” as used is denoted a polymer that turns to a liquid or becomes more liquid or less viscous when heated and that can take on new shapes by the application of heat and pressure.

By the term “PMMA” as used in the present invention are denoted copolymers of methylmethacrylate (MMA), for the copolymer of MMA the weight ratio of MMA inside the PMMA is at least 80 wt %.

By saying that a range from x to y in the present invention, it is meant that the upper and lower limit of this range are included, equivalent to at least x and up to y.

By the term “increased chemical resistance” is meant that the composition of the invention resist longer to exposure of chemicals, particularly liquid chemicals, compared to comparative compositions.

By saying that a range is between x and y in the present invention, it is meant that the upper and lower limit of this range are excluded, equivalent to more than x and less than y.

With regard to the polymeric composition (PC1) suitable for making moulded objects that resists to chemicals, said composition is comprising a (meth)acrylic copolymer (MP1) comprising monomers of methyl methacrylate and methacrylic acid. The (meth)acrylic copolymer (MP1) has a weight average molecular weight Mw between 50 000 g/mol and 300 000 g/mol and that the ratio of the monomeric units coming from methacrylic acid in said (meth)acrylic copolymer (MP1) is between 4 wt % and 20 wt %.

In a first preferred embodiment the polymeric composition (PC1) comprises at least 80 wt % of the (meth)acrylic copolymer (MP1). More preferably the polymeric composition (PC1) comprises at least 85 wt % of the (meth)acrylic copolymer (MP1), still more preferably at least 90 wt % of the (meth)acrylic copolymer (MP1), advantageously at least 95 wt % of the (meth)acrylic copolymer (MP1) and most advantageously at least 96 wt % of the (meth)acrylic copolymer (MP1). In the first preferred embodiment the polymeric composition (PC1) comprises from 80 wt % to 100 wt % of the (meth)acrylic copolymer (MP1), preferably the from 85 wt % of to 100 wt %, still more preferably from 90 wt % to 100 wt %, advantageously from 95 wt % to 100 wt % and most advantageously from 96 wt % to 100 wt % of the (meth)acrylic copolymer (MP1).

In a second preferred embodiment the polymeric composition (PC1) is the (meth)acrylic copolymer (MP1).

In a third preferred embodiment the polymeric composition (PC1) comprises less than 100 wt % of the (meth)acrylic copolymer (MP1). More preferably the polymeric composition (PC1) comprises less than 99.99 wt % of the (meth)acrylic copolymer (MP1), still more preferably less than 99.95 wt % of the (meth)acrylic copolymer (MP1), advantageously less than 99.9 wt % of the (meth)acrylic copolymer (MP1) and most advantageously less than 99.8 wt % of the (meth)acrylic copolymer (MP1).

In a fourth preferred embodiment the polymeric composition (PC1) comprises less than 100 wt % and more than 80 wt % of the (meth)acrylic copolymer (MP1), more preferably less than 99.99 wt % and more than 85 wt %, still more preferably less than 99.95 wt % and more than 90 wt %, advantageously less than 99.9 wt % and more than 96 wt % and most advantageously less than 99.8 wt % and more than 99 wt %.

In a fifth preferred embodiment the polymeric composition (PC1) comprises at least 99 wt % the (meth)acrylic copolymer (MP1).

Preferably the (meth)acrylic copolymer (MP1) has a weight average molecular weight Mw between 55 000 g/mol and 260 000 g/mol and more preferably between 57 000 g/mol and 200 000 g/mol and still more preferably between 60 000 g/mol and 150 000 g/mol.

In a first advantageous embodiment the (meth)acrylic copolymer (MP1) has a weight average molecular weight Mw between 70 000 g/mol and 190 000 g/mol and more advantageously between 80 000 g/mol and 190 000 g/mol.

In a second advantageous embodiment the (meth)acrylic copolymer (MP1) has a weight average molecular weight Mw between 60 000 g/mol and 190 000 g/mol and more advantageously between 60 000 g/mol and 150 000 g/mol.

In a third advantageous embodiment the (meth)acrylic copolymer (MP1) has a weight average molecular weight Mw between 60 000 g/mol and 105 000 g/mol and more advantageously between 60 000 g/mol and 100 000 g/mol.

By saying that the ratio of the monomeric units coming from methacrylic acid in said (meth)acrylic copolymer (MP1) is between 4 wt % and 20 wt %, is meant that the units can be still present in the copolymer as copolymerized monomers, but they do not have to. A part of the methacrylic acid units that have been copolymerized could be for example be dehydrated, and two neighboured methacrylic acid units could form an anhydride, for example a type of glutaric anhydride.

Preferably the ratio of the monomeric units coming from methacrylic acid in said (meth)acrylic copolymer (MP1) is between 4 wt % and 15 wt %.

In one embodiment, at least 5% of the polymerized methacrylic acid units are transformed to anhydrides.

In another embodiment, at least 20% of the polymerized methacrylic acid units are transformed to anhydrides.

In still another embodiment, at least 0.5% of the polymerized methacrylic acid units are transformed to anhydrides.

Preferably between 0.5% and 50% of the polymerized methacrylic acid units in the (meth)acrylic copolymer (MP1) are transformed to anhydrides and more preferably between 5% and 50%.

The (meth)acrylic copolymer (MP1) comprises preferably at least 80 wt % of methyl methacrylate and more preferably at least 85 wt % of methyl methacrylate. The (meth)acrylic copolymer (MP1) comprises preferably at most 96 wt % of methyl methacrylate and more preferably at most 95.5 wt % of methyl methacrylate.

In a first more preferred embodiment the ratio of the monomeric units coming from methacrylic acid in said (meth)acrylic copolymer (MP1) is between 4.5 wt % and 14 wt %.

In a second more preferred embodiment the ratio of the monomeric units coming from methacrylic acid in said (meth)acrylic copolymer (MP1) is between 6 wt % and 14 wt %.

In a third preferred more embodiment the ratio of the monomeric units coming from methacrylic acid in said (meth)acrylic copolymer (MP1) is between 6.5 wt % and 14 wt %.

In a fourth preferred more embodiment the ratio of the monomeric units coming from methacrylic acid in said (meth)acrylic copolymer (MP1) is between 7 wt % and 14 wt %.

As said before the (meth)acrylic copolymer (MP1) comprises preferably between 4 wt % and 15 wt % of the monomeric units coming from methacrylic acid in said (meth)acrylic copolymer (MP1). By this is meant that the polymerized methacrylic acid does not to have present as simple monomer unit in the polymeric chain anymore. It could happen that two methacrylic acid units form an anhydride unit. The part of anhydride units in the (meth)acrylic copolymer (MP1) is between 0 and 15 wt %.

In a first preferred embodiment the ratio of anhydride units in said (meth)acrylic copolymer (MP1) is between 0.1 wt % and 14 wt %, more preferably between 0.2 wt % and 12 wt % and still more preferably between 0.3 wt % and 10 wt %.

In a second preferred embodiment the ratio of anhydride units in said (meth)acrylic copolymer (MP1) is between 5 wt % and 14 wt %.

In a third preferred embodiment the ratio of anhydride units in said (meth)acrylic copolymer (MP1) is between 0.5 wt % and 14 wt %.

According to the invention, preferred and advantageous embodiments for different respective characteristics of the (meth)acrylic copolymer (MP1) can be combined in any combination. As for example the preferred weight average molecular weight Mw of the (meth)acrylic copolymer (MP1) can be combined with preferred ratio of the monomeric units coming from methacrylic acid in said (meth)acrylic copolymer (MP1); or as for example the preferred weight average molecular weight Mw of the (meth)acrylic copolymer (MP1) can be combined with preferred the ratio of anhydride units in said (meth)acrylic copolymer (MP1) or contact angle of (meth)acrylic copolymer (MP1).

The (meth)acrylic copolymer (MP1) has a contact angle of at least 8°. The contact angle is measured with diethyl phthalate according to the method described in the experimental part.

In a first preferred embodiment the contact angle is between 8° and 20°.

In a second preferred embodiment the contact angle is between 9° and 20°.

In a third preferred embodiment the contact angle is between 9° and 17°.

According to an additional aspect the present invention concerns a process for making a moulded object comprising the step of transforming the polymeric composition (PC1) suitable for making moulded objects that resists to chemicals.

The transformation can be made by injection molding, extrusion, coextrusion or extrusion/blow molding. Preferably the transformation is made by injection or extrusion and more preferably by injection moulding.

The process for making a moulded object according to the invention comprises the steps of
melting the polymeric composition (PC1) comprising a (meth)acrylic copolymer (MP1)
injecting or extruding the molten composition.

In a first preferred embodiment the process for making a moulded object according to the invention comprises the steps of
melting the polymeric composition (PC1) comprising a (meth)acrylic copolymer (MP1)
injecting the molten composition into a mould
applying pressure to the mould at least until the mould is completely filled with the molten composition.

According to a still further aspect the present invention concerns the use of the composition for making a moulded object.

The composition according to the invention can be transformed by injection molding, extrusion, coextrusion or extrusion/blow molding for the preparation of parts, profiled elements, sheets or films, for example, or for producing a moulded objet or an article.

According to a still further aspect the present invention concerns a moulded object made of the polymeric composition (PC1).

According to a still further aspect the present invention concerns the use of the polymeric composition (PC1) in a moulded object.

The moulded object of the invention can be in form of a sheet, block, film, tube or profiled element.

Examples for moulded objects or articles are light guides, lenses, automotive trims, parts of automotive rear and front lights, tail light, front covers, clusters, oven covers, home appliance parts, optical films, decorative films, capstock layers or containers.

According to a still further aspect the present invention concerns an object comprising the polymeric composition (PC1) or made of the polymeric composition (PC1). The object can be made directly or by assembling several moulded objects.

In a first preferred embodiment the objects are multilayer structures comprising a capstock layers, containers and point of sales.

In a second preferred embodiment the objects are display stands, notably cosmetic display stands; point of purchase displays, sign holders, boxes, risers, racks or showcases; cosmetic packaging.

### [Experimental Part]

### [Methods]

The molecular weight is measured by size exclusion chromatography (SEC). The chromatography column is calibrated with PMMA standards having a molecular weight between 402 g/mol and 1 900 000 g/mol. The average molecular weight are expressed in g/mol for the number and average molecular weight Mn and Mw respectively. For the measurement the concentration is 1 g/L.

The solvent resistance is measured in view of a cleaning solution as explained in the examples.

The contact angle is measured with an apparatus called DIGIDROP. As liquid diethyl phthalate is used. A drop of 1 μl is put on the substrate by means of a syringe and a mobile platform and the profile of this drop is monitored by recording at least 6 pictures per second. A software which allows an automatic extraction of the contact angle is used. As the drop spreads relatively fast, the measurement is made only for 5 to 6 seconds and only the values during the first 4 seconds are evaluated and the value between 2 and 4 seconds is taken.

The optical properties of the polymers are measured according to following method: light transmittance is measured according to the standard ASTM D1003.

The vicat temperature of the polymers are measured according to norm ISO 306 method B50.

### Examples

The series of examples concern the use of different (meth)acrylic copolymers (MP1) in or as polymeric composition (PC1).

Following abbreviations are used for the monomers of the (meth)acrylic copolymers:

MMA—methyl methacrylate

MAA—methacrylic acid

EA—ethyl acrylate

MA—methyl acrylate

TABLE 1
Compositions of the respective (meth)acrylic copolymers (MP1)

| | | Molecular | contact |
|---|---|---|---|
| | Composition | weight Mw | angle |
| | [wt %] | [g/mol] | [°] |
| Example 1 | MMA/MAA | 82 000 | 8-10 |
| | 95/5 | | |
| Example 2 | MMA/MAA | 67 000 | 11-13 |
| | 90/10 | | |
| Comparative | MMA/MAA | 120 000 | |
| example 1 | 97/3 | | |
| Comparative | MMA/EA | 92 000 | 7-9 |
| example 2 | 90/10 | | |
| Comparative | MMA/EA | 92 000 | |
| example 3 | 99.5/0.5 | | |
| Comparative | MMA/MA | 150 000 | |
| example 4 | 98/2 | | |

The composition in table 1 refers to the monomers units used during polymerization. As explained previously, the methacrylic acid could form anhydrides, so that in the polymeric chain a glutaric anhydride type structure is present, coming from anhydride formation of two initially incorporated methacrylic acid units in the polymeric chain.

Test samples are prepare from the respective composition in form of sheets having a dimension of 100 mm*100 mm*3 mm.

The chemical resistance is tested by spraying 3 times on the surface of the test samples in form of the sheet a liquid composition LC1 consisting of: 70 wt % Ethanol, 20% Turpentine and 10% Ethyl phthalate. The surface of sample is evaluated if it has undergone chemical aggression as surface dissolution or cracking as indication of chemical resistance. The resistance is evaluated by cleaning the surface of the sheets either dry or cleaning with the liquid composition LC1 after different exposure times.

Thus there is an evaluation by creating three classes: 1=good resistance; 2=fair resistance and 3=bad resistance.

Good resistance means that the surface can be easily cleaned by wiping the surface with a tissue only, without using any cleaning solution or solvent. Aesthetics of the surface remains unchanged after the test.

Fair resistance means that the surface can be cleaned by wiping the surface, but with necessity to use additionally a cleaning solution (ex: solvent, perfume, Ethanol) to remove all the deposit. A tissue only is not sufficient to clean by wiping. The aesthetics of the surface remains unchanged after the test.

Bad resistance, it means that the surface of the object is damaged (dissolution and/or cracking), which is not reversible.

TABLE 2
test results of sheets cleaned with LC1

| | Exposure time [h] | | |
|---|---|---|---|
| | 0.5 | 6 | 24 |
| Example 1 | 1 | 1 | 2 |
| Example 2 | 1 | 1 | 1 |
| Comparative example 1 | | | |
| Comparative example 2 | 3 | 3 | 3 |
| Comparative example 3 | 2 | 3 | 3 |
| Comparative example 4 | 1 | 2 | 3 |

TABLE 3
test results of sheets dry cleaned

| | Exposure time [h] | | |
|---|---|---|---|
| | 0.5 | 6 | 24 |
| Example 1 | 1 | 2 | 3 |
| Example 2 | 1 | 1 | 2 |
| Comparative example 1 | | | |
| Comparative example 2 | 3 | 3 | 3 |
| Comparative example 3 | 2 | 3 | 3 |
| Comparative example 4 | 2 | 3 | 3 |

The samples according to the invention have a better chemical resistance.

1. A polymeric composition (PC1) suitable for making moulded objects resistant to chemicals, the composition comprising a (meth)acrylic copolymer (MP1) comprising monomers of methyl methacrylate and methacrylic acid wherein the (meth)acrylic copolymer (MP1) has a weight average molecular weight Mw between 50 000 g/mol and 300 000 g/mol and wherein the ratio of the monomeric units coming from methacrylic acid in the (meth)acrylic copolymer (MP1) is between 4 wt % and 20 wt %.

2. The polymeric composition (PC1) according to claim 1, wherein the weight average molecular weight Mw is between 80 000 g/mol and 190,000 g/mol.

3. The polymeric composition (PC1) according to claim 1, wherein the weight average molecular weight Mw is between 60 000 g/mol and 150 000 g/mol.

4. The polymeric composition (PC1) according to claim 1, wherein the weight average molecular weight Mw is between 60,000 g/mol and 100,000 g/mol.

5. The polymeric composition (PC1) according to claim 1, wherein that the ratio of the monomeric units coming from methacrylic acid in said (meth)acrylic copolymer (MP1) is between 4.5 wt % and 14 wt %.

6. The polymeric composition (PC1) according to claim 1, wherein the ratio of the monomeric units coming from methacrylic acid in said (meth)acrylic copolymer (MP1) is between 6 wt % and 14 wt %.

7. The polymeric composition (PC1) according to claim 1, wherein the ratio of the monomeric units coming from methacrylic acid in the (meth)acrylic copolymer (MP1) is between 7 wt % and 14 wt %.

8. The polymeric composition (PC1) according to claim 1, wherein the (meth)acrylic copolymer (MP1) has a weight average molecular weight Mw between 60,000 g/mol and 150,000 g/mol and that the ratio of the monomeric units coming from methacrylic acid in the (meth)acrylic copolymer (MP1) is between 6 wt % and 14 wt %.

9. The polymeric composition (PC1) according to claim 1, wherein the (meth)acrylic copolymer (MP1) has a weight average molecular weight Mw between 60,000 g/mol and 100,000 g/mol and that the ratio of the monomeric units coming from methacrylic acid in said (meth)acrylic copolymer (MP1) is between 4.5 wt % and 14 wt %.

10. The polymeric composition (PC1) according to claim 1, wherein the polymeric composition comprises at least 99 wt % of the (meth)acrylic copolymer (MP1).

11. The polymeric composition (PC1) according to claim 1, wherein (meth)acrylic copolymer (MP1) comprises at least 80 wt % of methyl methacrylate.

12. The polymeric composition (PC1) according to claim 1, wherein (meth)acrylic copolymer (MP1) comprises anhydride units, the ratio of the anhydride units in the (meth)acrylic copolymer (MP1) is between 0.1 wt % and 14 wt %.

13. The polymeric composition (PC1) according to claim 1, wherein (meth)acrylic copolymer (MP1) comprises anhydride units, the ratio of the anhydride units in the (meth)acrylic copolymer (MP1) is between 0.5 wt % and 14 wt %.

14. The polymeric composition (PC1) according to claim 1, wherein (meth)acrylic copolymer (MP1) has a contact angle of at least 8°.

15. The polymeric composition (PC1) according to claim 1, wherein (meth)acrylic copolymer (MP1) has a contact angle between 8° and 20°.

16. A process for making a moulded object by transforming a polymeric composition (PC1) suitable for the composition comprising a (meth)acrylic copolymer (MP1) comprising monomers of methyl methacrylate and methacrylic acid, the process comprises the steps of:
a) providing a polymeric composition (PC1) according to claim 1;
b) transforming polymeric composition (PC1); and
c) assembling.

17. The process according to claim 16, wherein the polymeric composition (PC1) is transformed by injection molding, extrusion, coextrusion or extrusion/blow molding.

18. The process according to claim 16, wherein the process comprises the steps of
melting the polymeric composition (PC1) comprising a (meth)acrylic copolymer (MP1); and
injecting or extruding the molten composition.

19. The process according to claim 16, wherein the process comprises the steps of
melting the polymeric composition (PC1) comprising a (meth)acrylic copolymer (MP1);
injecting the molten composition into a mould; and
applying pressure to the mould at least until the mould is completely filled with the molten composition.

20. (canceled)

21. (canceled)

22. (canceled)

23. A moulded object comprising the composition according to claim 1 in form of a sheet, block, film, tube or profiled element.

24. A moulded object comprising the composition according to claim 1, wherein the moulded object is chosen from multilayer structures comprising a capstock layers, containers and point of sales.

25. A moulded object comprising the composition according to claim 1, wherein the moulded object is chosen display stands, notably cosmetic display stands; point of purchase displays, sign holders, boxes, risers, racks or showcases; cosmetic packaging.

26. A moulded object in form of an assembled display stand made of a polymeric composition (PC1) according to claim 1.
